(19) United States
(12) Patent Application Publication
(10) Pub. No.: US 2026/0361058 A1
(43) Pub. Date: Nov. 12, 2026

(54) ELECTRICAL JUNCTION BOX

(71) Applicant: AISAN KOGYO KABUSHIKI KAISHA, Obu-shi (JP)

(72) Inventors: Atsushi ISHIKAWA, Obu-shi (JP); Masaomi MORISHITA, Obu-shi (JP)

(21) Appl. No.: 19/665,382

(22) Filed: May 1, 2026

(30) Foreign Application Priority Data
May 12, 2025 (JP) 2025-079993

(51) Int. Cl. H02G 3/03; H02B 1/20; H02G 3/16

(52) U.S. Cl. CPC H02G 3/03; H02B 1/20; H02G 3/16

(57) ABSTRACT

An electrical junction box may include a first busbar; a second busbar spaced apart from the first busbar; a connection component electrically connecting the first busbar and the second busbar; and a heat dissipation sheet with which the first and second busbars are in contact. The connection component may be a component that generates heat when a current flows between the first and second busbars through the connection component. The first busbar may include a first contact portion that is in contact with the heat dissipation sheet at a position spaced apart from the connection component. The second busbar may include a second contact portion that is in contact with the heat dissipation sheet at a position spaced apart from the connection component. An area of the second contact portion may be 90% or more and less than 110% of an area of the first contact portion.

### CROSS REFERENCE TO RELATED APPLICATION

This application claims priority to Japanese Patent Application No. 2025-079993 filed on May 12, 2025. The entire content of the priority application is incorporated herein by reference.

### TECHNICAL FIELD

The art disclosed herein relates to an electrical junction box.

### BACKGROUND ART

Conventionally, technologies for dissipating heat of a heat-generating component (e.g., a relay) to the outside via a busbar are known. For example, Japanese Patent Application Publication No. 2024-3647 describes a circuit assembly including a heat-generating component. The circuit assembly of Japanese Patent Application Publication No. 2024-3647 includes a heat-generating component (a relay), a busbar electrically connected to the heat-generating component, and a thermally conductive sheet in contact with the busbar.

The circuit assembly of Japanese Patent Application Publication No. 2024-3647 can dissipate the heat of the heat-generating component by transferring it to the thermally conductive sheet via the busbar. However, there is still room for further improvements to efficiently dissipate heat of a heat-generating component. The disclosure herein provides a technology for efficiently dissipating heat of a heat-generating component via a first busbar and a second busbar.

### SUMMARY

An electrical junction box may comprise a first busbar; a second busbar spaced apart from the first busbar; a connection component electrically connecting the first busbar and the second busbar; and a heat dissipation sheet with which the first busbar and the second busbar are in contact. The connection component may be a component that generates heat when a current flows between the first busbar and the second busbar through the connection component. The first busbar may comprise a first contact portion that is in contact with the heat dissipation sheet at a position spaced apart from the connection component. The second busbar may comprise a second contact portion that is in contact with the heat dissipation sheet at a position spaced apart from the connection component. An area of the second contact portion may be 90% or more and less than 110% of an area of the first contact portion.

### BRIEF DESCRIPTION OF DRAWINGS

FIG. 1 is a top view of the inside of a housing of an electrical junction box according to an embodiment.

FIG. 2 a top view of the inside of the housing of the electrical junction box according to the embodiment, where depiction of a relay is omitted.

FIG. 3 is a cross-sectional view taken along line III-III in FIG. 1.

FIG. 4 is a cross-sectional view taken along line IV-IV in FIG. 1.

FIG. 5 is an enlarged view of a region V in FIG. 2.

FIG. 6 is a cross-sectional view according to a modification corresponding to FIG. 3.

FIG. 7 is a cross-sectional view according to the modification corresponding to FIG. 4.

### DETAILED DESCRIPTION

In one aspect of the present teachings, an electrical junction box may comprise a first busbar; a second busbar spaced apart from the first busbar; a connection component electrically connecting the first busbar and the second busbar; and a heat dissipation sheet with which the first busbar and the second busbar are in contact. The connection component may be a component that generates heat when a current flows between the first busbar and the second busbar through the connection component. The first busbar may comprise a first contact portion that is in contact with the heat dissipation sheet at a position spaced apart from the connection component. The second busbar may comprise a second contact portion that is in contact with the heat dissipation sheet at a position spaced apart from the connection component. An area of the second contact portion may be 90% or more and less than 110% of an area of the first contact portion.

With the configuration above, heat of the heat-generating component (i.e., the connection component) can be dissipated from the heat dissipation sheet via the first busbar and the second busbar. Since there is no large difference between the area of the first contact portion of the first busbar and the area of the second contact portion of the second busbar, the heat of the heat-generating component is not distributed unevenly between the busbars, thereby efficiently dissipating the heat of the heat-generating component.

In one embodiment of the present teachings, at least one of the first contact portion and the second contact portion may comprise a projecting portion to increase a contact area with the heat dissipation sheet. This configuration can improve heat dissipation performance.

In one embodiment of the present teachings, at least one of the first busbar and the second busbar may comprise a vicinity portion that is located in the vicinity of the connection component but does not contact the heat dissipation sheet. An area of the vicinity portion may be larger than the area of the first contact portion and the area of the second contact portion. This configuration allows a part of heat of the heat-generating component (i.e., the connection component) transferred to the first busbar and the second busbar to be dissipated from the vicinity portion.

In one embodiment of the present teachings, at least one of the first busbar and the second busbar may comprise an extending portion extending from a connection portion of the at least one of the first busbar and the second busbar that is connected to the connection component toward the heat dissipation sheet. The at least one of the first busbar and the second busbar further may comprise a first curved portion that is located in the extending portion and protrudes in a curved manner in a direction intersecting an extending direction of the extending portion.

With the configuration above, owing to the presence of the first curved portion, the extending portion can flexibly bend while the contact portion of the at least one of the first busbar and the second busbar is in contact with the heat dissipation sheet. This improves the degree of contact between the contact portion of the at least one of the first busbar and the second busbar and the heat dissipation sheet.

In one embodiment of the present teachings, at least one of the first contact portion and the second contact portion may extend along the heat dissipation sheet and may comprise a second curved portion that protrudes in a curved manner in a direction intersecting an extending direction of the at least one of the first contact portion and the second contact portion.

With the configuration above, owing to the presence of the second curved portion, the at least one of the first contact portion and the second contact portion can flexibly bend while the at least one of the first contact portion and the second contact portion is in contact with the heat dissipation sheet. This improves the degree of contact between the at least one of the first contact portion and the second contact portion and the heat dissipation sheet.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved electrical junction boxes.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

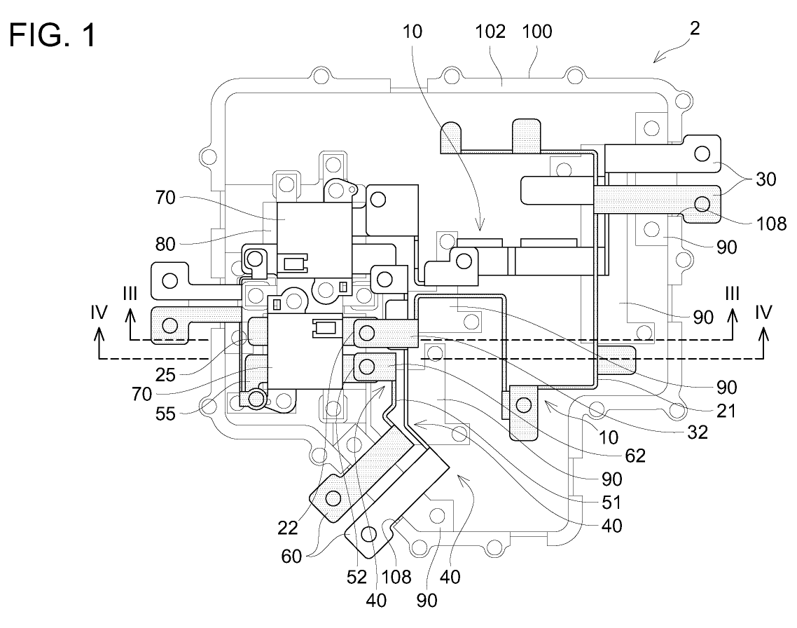

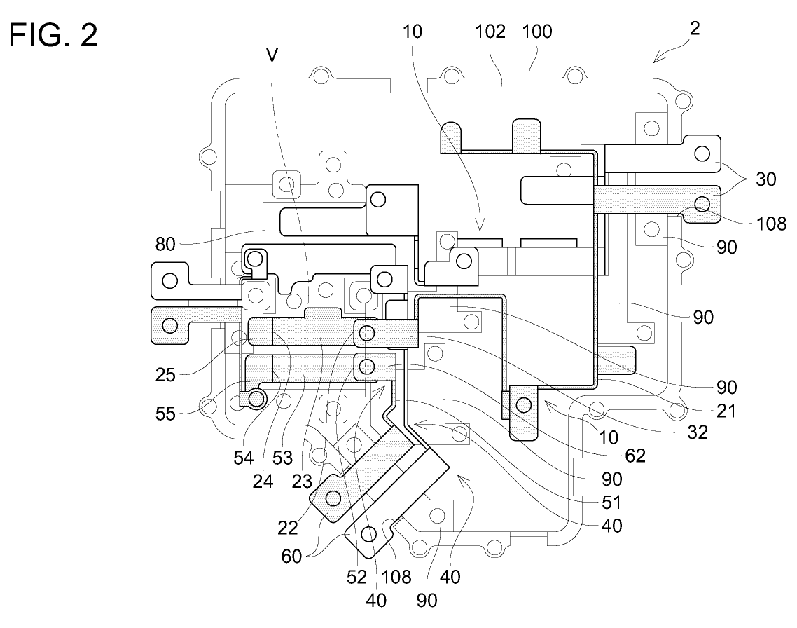

Referring to the drawings, an electrical junction box 2 according to an embodiment is described. As illustrated in FIGS. 1-4, the electrical junction box 2 comprises a housing 100 and a heat dissipation sheet 80 housed in the housing 100. The electrical junction box 2 further comprises first busbars 10, second busbars 40, and relays 70 all housed in the housing 100.

The housing 100 is formed of, for example, an insulating resin (e.g., polyethylene, polypropylene, etc.). The housing 100 comprises a container 102 and a lid 104. The container 102 and the lid 104 are fastened to each other with a fastener 106 (e.g., a bolt, a screw, etc.). The housing 100 has a plurality of openings 108 through which end portions of the busbars 10, 40 extend to the outside of the housing 100. The openings 108 are formed in a side surface of the housing 100.

The housing 100 comprises a cooler 6 attached to the container 102. The cooler 6 is attached to the container 102 so as to oppose the heat dissipation sheet 80 housed in the housing 100. For example, the cooler 6 comprises a flow passage through which a coolant flows and cools the housing 100 and the heat dissipation sheet 80 by the coolant flowing through the flow passage.

The heat dissipation sheet 80 is disposed on a bottom 102a of the container 102 of the housing 100. The heat dissipation sheet 80 is located below the relays 70 and separated away from the relays 70. The heat dissipation sheet 80 laterally extends on the bottom 102a of the container 102. The heat dissipation sheet 80 is electrically insulative and thermally conductive. For example, the heat dissipation sheet 80 is formed of a resin (e.g., rubber, silicon, etc.). The heat dissipation sheet 80 can dissipate heat transferred from the first busbars 10 and the second busbars 40.

The electrical junction box 2 comprises a pair of first busbars 10, 10 (for positive and negative electrodes), a pair of second busbars 40, 40 (for positive and negative electrodes), and a pair of relays 70, 70 (for positive and negative electrodes).

Hereinafter, a first busbar 10 (for positive electrode) of the pair of first busbars 10 is described. Since the other first busbar 10 (for negative electrode) has the same configuration as that of the first busbar 10 (for positive electrode) described below, detailed description of the other first busbar 10 is omitted. Similarly, a second busbar 40 (for positive electrode) of the pair of second busbars 40 is described below. Since the other second busbar 40 (for negative electrode) has the same configuration as that of the second busbar 40 (for positive electrode) described below, detailed description of the other second busbar 40 is omitted. Similarly, a relay 70 (for positive electrode) of the pair of relays 70 is described below. Since the other relay 70 (for negative electrode) has the same configuration as that of the relay 70 (for positive electrode) described below, detailed description of the other relay 70 is omitted.

First, the first busbar 10 is described. The first busbar 10 is formed of an electrically conductive metal (e.g., copper, aluminum, etc.). The shape of the first busbar 10 is not particularly limited. The first busbar 10 is formed, for example, by stamping and bending a metal plate. The first busbar 10 may comprise a single metal member or a combination of multiple metal members.

The first busbar 10 is fixed to a plurality of support members 90 in the housing 100. The first busbar 10 is supported by the plurality of support members 90. The plurality of support members 90 is fixed to the housing 100. Thus, the first busbar 10 is fixed to the housing 100 via the plurality of support members 90.

The first busbar 10 is an input-side busbar to which electric power is input from an external power supply (not illustrated). The first busbar 10 comprises a first extending portion 21, a second extending portion 22, a third extending portion 23, a fourth extending portion 24, and a fifth extending portion 25.

The first extending portion 21 extends from the outside of the housing 100 to the inside of the housing 100. The first extending portion 21 extends from the outside of the housing 100 to the second extending portion 22. The first extending portion 21 extends to the second extending portion 22 while bending in various directions. The first extending portion 21 extends laterally between the container 102 and the lid 104 of the housing 100.

The first extending portion 21 comprises an input terminal 30 projecting to the outside of the housing 100. The input terminal 30 is located in one end portion of the first extending portion 21. The input terminal 30 projects to the outside of the housing 100 through an opening 108 of the housing 100. The input terminal 30 is electrically connected to the external power supply (not illustrated). Electric power is supplied from the external power supply (not illustrated) to the first busbar 10 via the input terminal 30.

The first extending portion 21 further comprises a vicinity portion 32 located in the other end portion of the first extending portion 21. The vicinity portion 32 is located in the end portion of the first extending portion 21 that is opposite to the end portion thereof in which the input terminal 30 is located, and is located in the vicinity of the relay 70. The vicinity portion 32 is located adjacent to the relay 70 in the housing 100. The vicinity portion 32 is spaced apart from the heat dissipation sheet 80. The vicinity portion 32 is not in contact with the heat dissipation sheet 80. The area of the vicinity portion 32 may be larger than the area of the third extending portion 23 of the first busbar 10 as described later. For example, the area of the vicinity portion 32 is 110% or more of the area of the third extending portion 23 of the first busbar 10. The area of the vicinity portion 32 may be larger than the area of a third extending portion 53 of the second busbar 40 as described later. For example, the area of the vicinity portion 32 is 110% or more of the area of the third extending portion 53 of the second busbar 40. If the first busbar 10 is formed by combining multiple metal members, the multiple metal members may be joined to each other in the vicinity portion 32.

The second extending portion 22 extends vertically from the other end portion of the first extending portion 21. The second extending portion 22 is joined to the vicinity portion 32 of the first extending portion 21. The second extending portion 22 extends from the other end portion of the first extending portion 21 toward the heat dissipation sheet 80. The second extending portion 22 extends in a direction intersecting the heat dissipation sheet 80. The second extending portion 22 is located between the first extending portion 21 and the third extending portion 23. The second extending portion 22 extends from the first extending portion 21 to the third extending portion 23.

The third extending portion 23 extends laterally from the lower end of the second extending portion 22. The third extending portion 23 extends laterally between the relay 70 and the heat dissipation sheet 80. The third extending portion 23 extends from the lower end of the second extending portion 22 in a direction along the upper surface of the heat dissipation sheet 80. The third extending portion 23 is located between the second extending portion 22 and the fourth extending portion 24. The third extending portion 23 extends from the second extending portion 22 to the fourth extending portion 24.

The third extending portion 23 is located below the relay 70. The third extending portion 23 is located so as to overlap the relay 70 in an up-down direction. The third extending portion 23 is covered by the relay 70 but is separated away from the relay 70 in the up-down direction. The third extending portion 23 is located between the relay 70 and the heat dissipation sheet 80 in the up-down direction. The third extending portion 23 is in contact with the upper surface of the heat dissipation sheet 80. The entire lower surface of the third extending portion 23 is in contact with the upper surface of the heat dissipation sheet 80.

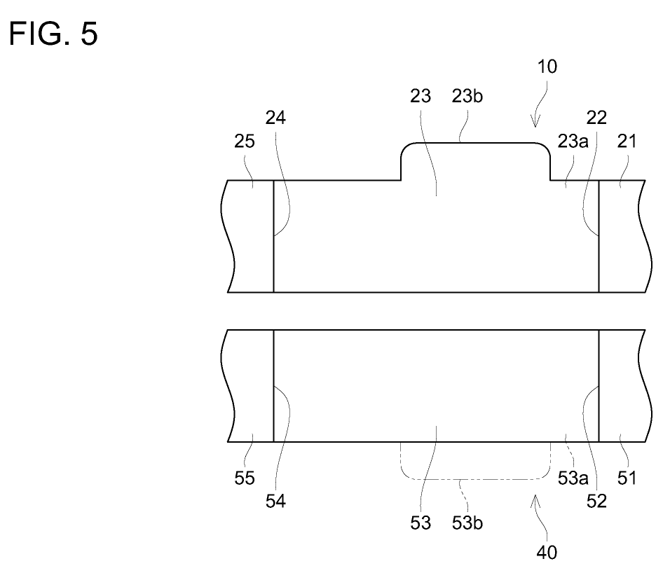

As illustrated in FIG. 5, the third extending portion 23 comprises a body portion 23a and a projecting portion 23b projecting from the body portion 23a. The projecting portion 23b is provided to increase the contact area between the third extending portion 23 and the heat dissipation sheet 80. The projecting portion 23b projects in the in-plane direction of the third extending portion 23 (i.e., in a direction parallel to the contact plane between the third extending portion 23 and the heat dissipation sheet 80). The area of the projecting portion 23b is smaller than the area of the body portion 23a. In a modification, the third extending portion 23 may not comprise the projecting portion 23b.

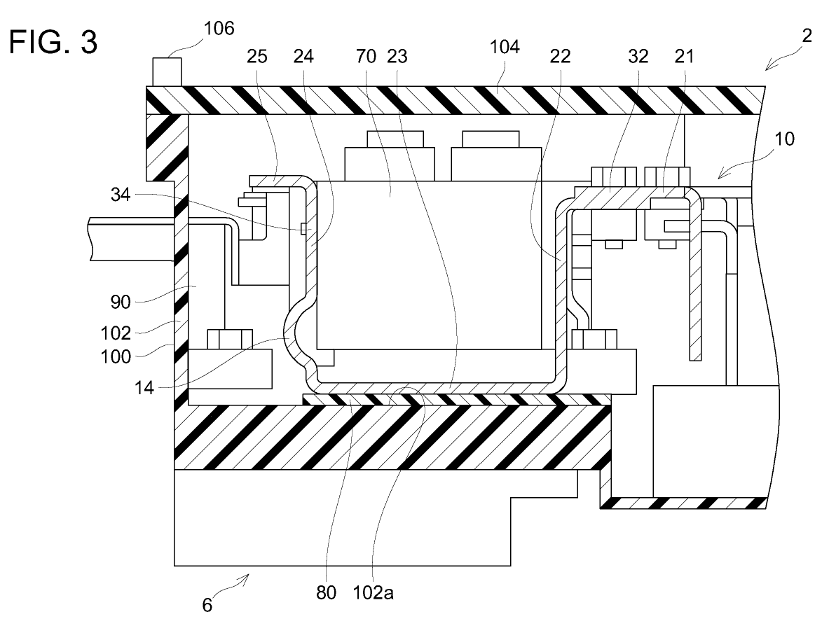

As illustrated in FIG. 3, the fourth extending portion 24 opposes the second extending portion 22 with the relay 70 interposed therebetween. The relay 70 is located between the fourth extending portion 24 and the second extending portion 22. The fourth extending portion 24 extends vertically from an end of the third extending portion 23 (i.e., the end of the third extending portion 23 opposite to the second extending portion 22). As seen from the third extending portion 23, the fourth extending portion 24 extends from the end of the third extending portion 23 away from the heat dissipation sheet 80. The fourth extending portion 24 extends in the direction intersecting the heat dissipation sheet 80. The fourth extending portion 24 is located between the third extending portion 23 and the fifth extending portion 25. The fourth extending portion 24 extends from the third extending portion 23 to the fifth extending portion 25. As seen from the fifth extending portion 25, the fourth extending portion 24 extends vertically from an end of the fifth extending portion 25 toward the heat dissipation sheet 80.

The fourth extending portion 24 comprises a connection portion 34 electrically connected to the relay 70. A terminal of the relay 70 is fixed to the connection portion 34 of the fourth extending portion 24. A current flows between the fourth extending portion 24 and the relay 70 via the connection portion 34.

The fourth extending portion 24 comprises a first curved portion 14 in a portion extending from the connection portion 34 toward the heat dissipation sheet 80. The first curved portion 14 is located between the connection portion 34 of the fourth extending portion 24 and the third extending portion 23. In a modification, a plurality of first curved portions 14 may be located between the connection portion 34 of the fourth extending portion 24 and the third extending portion 23. The first curved portion 14 projects in a curved manner in a direction intersecting the extending direction of the fourth extending portion 24. The first curved portion 14 projects in the out-of-plane direction of the fourth extending portion 24. The first curved portion 14 projects away from the relay 70.

The fifth extending portion 25 extends laterally from the upper end of the fourth extending portion 24. The fifth extending portion 25 is fixed to a support member 90 in the housing 100.

Next, the second busbar 40 is described. The second busbar 40 is formed of an electrically conductive metal (e.g., copper, aluminum, etc.). The shape of the second busbar 40 is not particularly limited. The second busbar 40 is formed, for example, by stamping and bending a metal plate. The second busbar 40 may comprise a single metal member or a combination of multiple metal members.

The second busbar 40 is fixed to a plurality of support members 90 in the housing 100. The second busbar 40 is supported by the plurality of support members 90. The plurality of support members 90 is fixed to the housing 100. Thus, the second busbar 40 is fixed to the housing 100 via the plurality of support members 90.

The second busbar 40 is an output-side busbar from which electric power is output to an external load (not illustrated). The second busbar 40 comprises a first extending portion 51, a second extending portion 52, a third extending portion 53, a fourth extending portion 54, and a fifth extending portion 55.

The first extending portion 51 extends from the outside of the housing 100 to the inside of the housing 100. The first extending portion 51 extends from the outside of the housing 100 to the second extending portion 52. The first extending portion 51 extends to the second extending portion 52 while bending in various directions. The first extending portion 51 extends laterally between the container 102 and the lid 104 of the housing 100.

The first extending portion 51 comprises an output terminal 60 projecting to the outside of the housing 100. The output terminal 60 is located in one end portion of the first extending portion 51. The output terminal 60 projects to the outside of the housing 100 through an opening 108 of the housing 100. The output terminal 60 is electrically connected to the external load (not illustrated). Electric power is supplied from the second busbar 40 to the external load (not illustrated) via the output terminal 60.

The first extending portion 51 further comprises a vicinity portion 62 located in the other end portion of the first extending portion 51. The vicinity portion 62 is located in the end portion of the first extending portion 51 that is opposite to the end portion thereof in which the output terminal 30 is located, and is located in the vicinity of the relay 70. The vicinity portion 62 is located adjacent to the relay 70 in the housing 100. The vicinity portion 62 is spaced apart from the heat dissipation sheet 80. The vicinity portion 62 is not in contact with the heat dissipation sheet 80. The area of the vicinity portion 62 may be larger than the area of the third extending portion 53 of the second busbar 40 as described later. For example, the area of the vicinity portion 62 is 110% or more of the area of the third extending portion 53 of the second busbar 40. The area of the vicinity portion 62 may be larger than the area of the third extending portion 23 of the first busbar 10. For example, the area of the vicinity portion 62 is 110% or more of the area of the third extending portion 23 of the first busbar 10. If the second busbar 40 is formed by combining multiple metal members, the multiple metal members may be joined to each other in the vicinity portion 62.

The second extending portion 52 extends vertically from the other end portion of the first extending portion 51. The second extending portion 52 is joined to the vicinity portion 62 of the first extending portion 51. The second extending portion 52 extends from the other end portion of the first extending portion 51 toward the heat dissipation sheet 80. The second extending portion 52 extends in the direction intersecting the heat dissipation sheet 80. The second extending portion 52 is located between the first extending portion 51 and the third extending portion 53. The second extending portion 52 extends from the first extending portion 51 to the third extending portion 53.

The third extending portion 53 extends laterally from the lower end of the second extending portion 52. The third extending portion 53 extends laterally between the relay 70 and the heat dissipation sheet 80. The third extending portion 53 extends from the lower end of the second extending portion 52 in the direction along the upper surface of the heat dissipation sheet 80. The third extending portion 53 is located between the second extending portion 52 and the fourth extending portion 54. The third extending portion 53 extends from the second extending portion 52 to the fourth extending portion 54.

The third extending portion 53 is located below the relay 70. The third extending portion 53 is located so as to overlap the relay 70 in the up-down direction. The third extending portion 53 is covered by the relay 70 but is separated away from the relay 70 in the up-down direction. The third extending portion 53 is located between the relay 70 and the heat dissipation sheet 80 in the up-down direction. The third extending portion 53 is in contact with the upper surface of the heat dissipation sheet 80. The entire lower surface of the third extending portion 53 is in contact with the upper surface of the heat dissipation sheet 80.

In a modification, as illustrated in FIG. 5, the third extending portion 53 may comprise a body portion 53a and a projecting portion 53b projecting from the body portion 53a. The projecting portion 53b is provided to increase the contact area between the third extending portion 53 and the heat dissipation sheet 80. The projecting portion 53b projects in the in-plane direction of the third extending portion 53 (i.e., in a direction parallel to the contact plane between the third extending portion 53 and the heat dissipation sheet 80). The area of the projecting portion 53b is smaller than the area of the body portion 53a. In the present embodiment, the third extending portion 53 does not comprise the projecting portion 53b.

The third extending portion 53 of the second busbar 40 is spaced apart from the third extending portion 23 of the first busbar 10 in the direction along the upper surface of the heat dissipation sheet 80. The area of the third extending portion 53 of the second busbar 40 is 90% or more and less than 110% of the area of the third extending portion 23 of the first busbar 10.

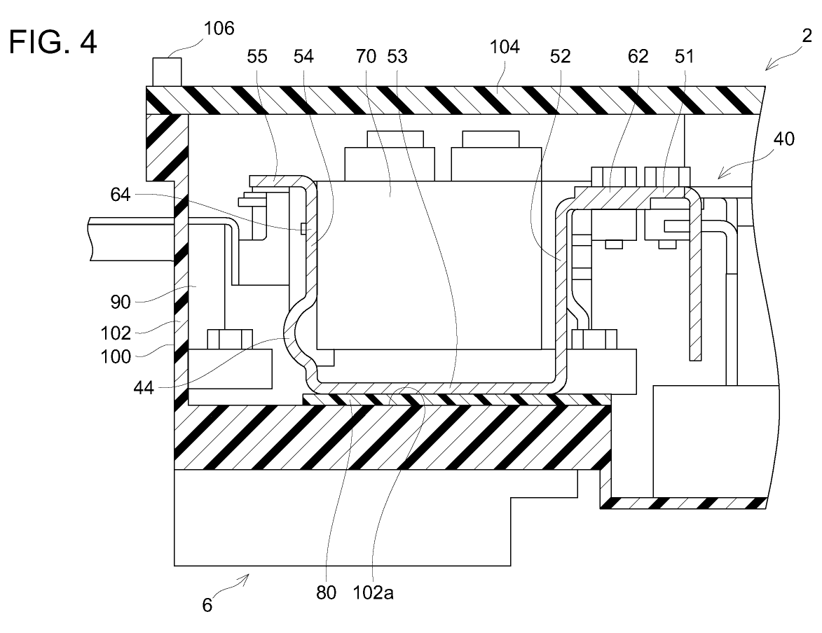

As illustrated in FIG. 4, the fourth extending portion 54 opposes the second extending portion 52 with the relay 70 interposed therebetween. The relay 70 is located between the fourth extending portion 54 and the second extending portion 52. The fourth extending portion 54 extends vertically from an end of the third extending portion 53 (i.e., the end of the third extending portion 53 opposite to the second extending portion 22). As seen from the third extending portion 53, the fourth extending portion 54 extends from the end of the third extending portion 53 away from the heat dissipation sheet 80. The fourth extending portion 54 extends in the direction intersecting the heat dissipation sheet 80. The fourth extending portion 54 is located between the third extending portion 53 and the fifth extending portion 55. The fourth extending portion 54 extends from the third extending portion 53 to the fifth extending portion 55. As seen from the fifth extending portion 55, the fourth extending portion 54 extends vertically from an end of the fifth extending portion 55 toward the heat dissipation sheet 80.

The fourth extending portion 54 comprises a connection portion 64 electrically connected to the relay 70. A terminal of the relay 70 is fixed to the connection portion 64 of the fourth extending portion 54. A current flows between the fourth extending portion 54 and the relay 70 via the connection portion 64.

The fourth extending portion 54 comprises a first curved portion 44 in a portion extending from the connection portion 64 toward the heat dissipation sheet 80. The first curved portion 44 is located between the connection portion 64 of the fourth extending portion 54 and the third extending portion 53. In a modification, a plurality of first curved portions 44 may be located between the connection portion 64 of the fourth extending portion 54 and the third extending portion 53. The first curved portion 44 projects in a curved manner in a direction intersecting the extending direction of the fourth extending portion 54. The first curved portion 44 projects in the out-of-plane direction of the fourth extending portion 54. The first curved portion 44 projects away from the relay 70.

The fifth extending portion 55 extends laterally from the upper end of the fourth extending portion 54. The fifth extending portion 55 is fixed to a support member 90 in the housing 100.

Next, the relay 70 is described. The relay 70 is located in the housing 100 so as to cover the third extending portion 23 of the first busbar 10 and the third extending portion 53 of the second busbar 40. The relay 70 is a component configured to electrically connect and disconnect the first busbar 10 and the second busbar 40. For example, one terminal of the relay 70 is connected to the first busbar 10, and the other terminal of the relay 70 is connected to the second busbar 40. When the relay 70 is turned on, the busbars 10 and 40 are electrically connected. When the relay 70 is turned off, the busbars 10 and 40 are electrically disconnected. When the relay 70 is turned on, a current flows between the busbars 10 and 40. The relay 70 generates heat when a current flows between the first busbar 10 and the second busbar 40 through the relay 70. The relay 70 is an example of heat-generating component.

In the electrical junction box 2 described above, when the relay 70 is turned on while electric power is being supplied from the external power supply to the first busbar 10, a current flows between the first busbar 10 and the second busbar 40 through the relay 70. Thereby, the relay 70 generates heat. The heat generated by the relay 70 is transferred to the heat dissipation sheet 80 through the first busbar 10 and the second busbar 40. The heat dissipation sheet 80 dissipates the heat transferred through the first busbar 10 and the second busbar 40 to the outside. The heat dissipation sheet 80 is cooled by the cooler 6 attached to the housing 100.

### Advantageous Effects

The electrical junction box 2 according to the embodiment has been described. As is clear from the above description, the electrical junction box 2 comprises the relay 70 (an example of connection component) electrically connecting the first busbar 10 and the second busbar 40; and the heat dissipation sheet 80 with which the first busbar 10 and the second busbar 40 are in contact. The relay 70 generates heat when a current flows between the first busbar 10 and the second busbar 40 through the relay 70. The first busbar 10 comprises the third extending portion 23 (an example of first contact portion) that is in contact with the heat dissipation sheet 80 at a position spaced apart from the relay 70. The second busbar 40 comprises the third extending portion 53 (an example of second contact portion) that is in contact with the heat dissipation sheet 80 at a position spaced apart from the relay 70. The area of the third extending portion 53 of the second busbar 40 is 90% or more and less than 110% of the area of the third extending portion 23 of the first busbar 10.

With the configuration above, the heat of the relay 70 (i.e., a heat-generating component) can be dissipated from the heat dissipation sheet 80 via the first busbar 10 and the second busbar 40. Since there is no large difference between the area of the third extending portion 23 of the first busbar 10 and the area of the third extending portion 53 of the second busbar 40, the heat of the relay 70 is not distributed unevenly between the busbars, thereby efficiently dissipating the heat of the relay 70.

The third extending portion 23 of the first busbar 10 comprises the projecting portion 23b to increase the contact area with the heat dissipation sheet 80. This configuration can improve heat dissipation performance. The same applies to the third extending portion 53 of the second busbar 40.

The first busbar 10 comprises the vicinity portion 32 that is located in the vicinity of the relay 70 but does not contact the heat dissipation sheet 80. The area of the vicinity portion 32 is larger than the area of the third extending portion 23 of the first busbar 10 and the area of the third extending portion 53 of the second busbar 40. This configuration allows a part of heat of the heat-generating component (i.e., the relay 70) transferred to the first busbar 10 to be dissipated from the vicinity portion 32. The same applies to the vicinity portion 62 of the second busbar 40.

The first busbar 10 comprises the first curved portion 14 in the fourth extending portion 24 that extends from the connection portion 34 electrically connected to the relay 70 toward the heat dissipation sheet 80. The first curved portion 14 protrudes in a curved manner in the direction intersecting the extending direction of the fourth extending portion 24. With this configuration, owing to the presence of the first curved portion 14, the fourth extending portion 24 can flexibly bend while the third extending portion 23 of the first busbar 10 is in contact with the heat dissipation sheet 80. This can improve the degree of contact between the third extending portion 23 of the first busbar 10 and the heat dissipation sheet 80. The same applies to the first curved portion 44 of the fourth extending portion 54 of the second busbar 40.

### Modifications

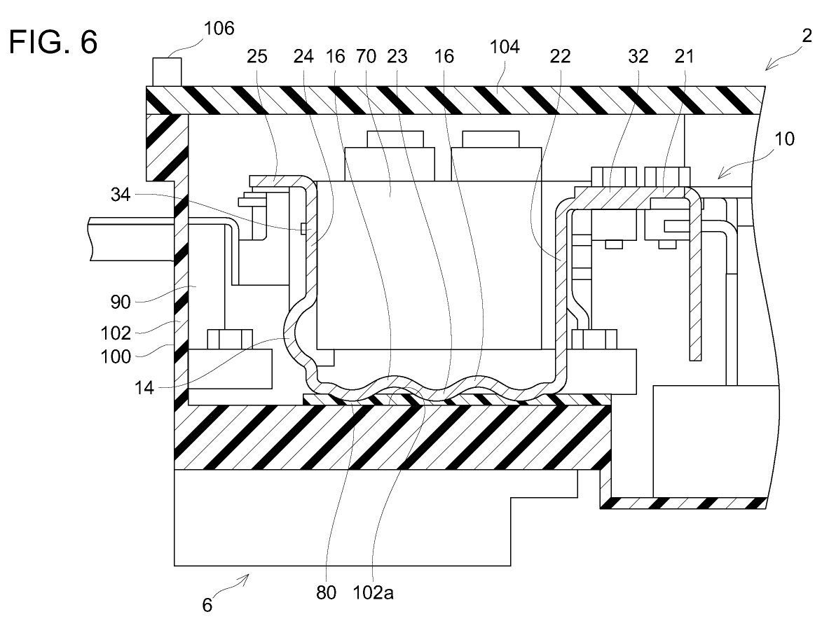

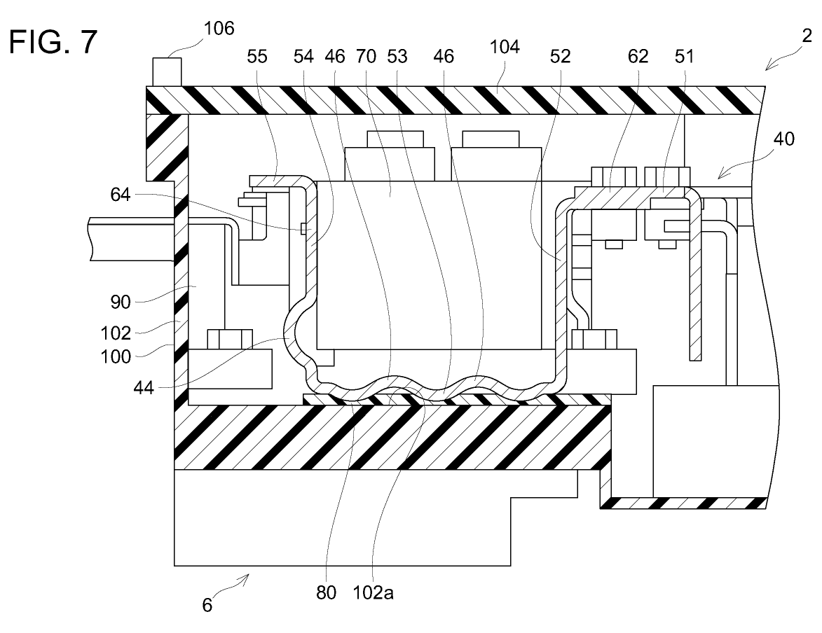

(1) In a modification, as illustrated in FIG. 6, the third extending portion 23 of the first busbar 10 may comprise one or more second curved portions 16. The one or more second curved portions 16 are spaced from each other in the extending direction of the third extending portion 23. The one or more second curved portions 16 are spaced from each other in the direction along the upper surface of the heat dissipation sheet 80.
   The one or more second curved portions 16 each protrude in a curved manner in a direction intersecting the extending direction of the third extending portion 23. The one or more second curved portions 16 protrude in a curved manner in the direction intersecting the upper surface of the heat dissipation sheet 80. The one or more second curved portions 16 protrude in the out-of-plane direction of the third extending portion 23 (i.e., in a direction intersecting the contact plane between the third extending portion 23 and the heat dissipation sheet 80).
   With the configuration above, owing to the presence of the one or more second curved portions 16, the third extending portion 23 can flexibly bend while the third extending portion 23 of the first busbar 10 is in contact with the heat dissipation sheet 80. This can improve the degree of contact between the third extending portion 23 of the first busbar 10 and the heat dissipation sheet 80.
(2) In a modification, as illustrated in FIG. 7, the third extending portion 53 of the second busbar 40 may comprise one or more second curved portions 46. The one or more second curved portions 46 are spaced from each other in the extending direction of the third extending portion 53. The one or more second curved portions 46 are spaced from each other in the direction along the upper surface of the heat dissipation sheet 80.
   The one or more second curved portions 46 each protrude in a curved manner in a direction intersecting the extending direction of the third extending portion 53. The one or more second curved portions 46 protrude in a curved manner in the direction intersecting the upper surface of the heat dissipation sheet 80. The one or more second curved portions 46 protrude in the out-of-plane direction of the third extending portion 53 (i.e., in a direction intersecting the contact plane between the third extending portion 53 and the heat dissipation sheet 80).
   With the configuration above, owing to the presence of the one or more second curved portions 46, the third extending portion 53 can flexibly bend while the third extending portion 53 of the second busbar 40 is in contact with the heat dissipation sheet 80. This can improve the degree of contact between the third extending portion 53 of the second busbar 40 and the heat dissipation sheet 80.
(3) In the embodiment described above, the first busbar 10 is an input-side busbar and the second busbar 40 is an output-side busbar. However, in a modification, the first busbar 10 may be an output-side busbar and the second busbar 40 may be an input-side busbar.
(4) In the embodiment described above, the first busbar 10 is connected to the relay 70 in the fourth extending portion 24, however, this need not always be the case. In a modification, the first busbar 10 may be connected to the relay 70 in its portion other than the fourth extending portion 24. The same applies to the second busbar 40.

What is claimed is:

1. An electrical junction box comprising:
a first busbar;
a second busbar spaced apart from the first busbar;
a connection component electrically connecting the first busbar and the second busbar; and
a heat dissipation sheet with which the first busbar and the second busbar are in contact,
wherein
the connection component is a component that generates heat when a current flows between the first busbar and the second busbar through the connection component,
the first busbar comprises a first contact portion that is in contact with the heat dissipation sheet at a position spaced apart from the connection component,
the second busbar comprises a second contact portion that is in contact with the heat dissipation sheet at a position spaced apart from the connection component, and
an area of the second contact portion is 90% or more and less than 110% of an area of the first contact portion.

2. The electrical junction box according to claim 1, wherein at least one of the first contact portion and the second contact portion comprises a projecting portion to increase a contact area with the heat dissipation sheet.

3. The electrical junction box according to claim 1, wherein at least one of the first busbar and the second busbar comprises a vicinity portion that is located in the vicinity of the connection component but does not contact the heat dissipation sheet, and
an area of the vicinity portion is larger than each of the area of the first contact portion and the area of the second contact portion.

4. The electrical junction box according to claim 1, wherein at least one of the first busbar and the second busbar comprises an extending portion extending from a connection portion of the at least one of the first busbar and the second busbar that is connected to the connection component toward the heat dissipation sheet, and
the at least one of the first busbar and the second busbar further comprises a first curved portion that is located in the extending portion and protrudes in a curved manner in a direction intersecting an extending direction of the extending portion.

5. The electrical junction box according to claim 1, wherein at least one of the first contact portion and the second contact portion extends along the heat dissipation sheet and comprises a second curved portion that protrudes in a curved manner in a direction intersecting an extending direction of the at least one of the first contact portion and the second contact portion.
